(19) United States
(12) Patent Application Publication
(10) Pub. No.: US 2011/0284757 A1
(43) Pub. Date: Nov. 24, 2011

(54) APPARATUS, METHOD AND SYSTEM FOR MEASURING PROMPT GAMMA AND OTHER BEAM-INDUCED RADIATION DURING HADRON THERAPY TREATMENTS FOR DOSE AND RANGE VERIFICATION PURPOSES USING IONIZATION RADIATION DETECTION

(75) Inventors: Cornel Butuceanu, Hampton, VA (US); Nathan Baillie, Williamsburg, VA (US); Cynthia E. Keppel, Norfolk, VA (US)

(73) Assignee: Hampton University, Hampton, VA (US)

(21) Appl. No.: 13/105,867

(22) Filed: May 11, 2011

Related U.S. Application Data
(60) Provisional application No. 61/333,597, filed on May 11, 2010.

(51) Int. Cl. G01T 1/185; G01T 1/28

(52) U.S. Cl. 250/389; 250/336.1; 250/395

(57) ABSTRACT

An apparatus, method and system for measurement of radiation during or directly following hadron therapy treatment for dose and range verification purposes accomplished through measurement of prompt gamma and other beam-induced radiation. One example includes the measurement of secondary prompt gamma radiation during proton and carbon ion beam irradiation. The measurement can also be made of other beam-induced radiation results. The measurement of gamma radiation or other beam-induced radiation allows for optimization of radiation dose disposition to the target tissue, with improved sparing of surrounding critical structures and normal tissue. Adjustments to a radiation treatment may be made as needed based on actual and measured applied dosages.

### BACKGROUND INVENTION

This application claims priority and benefit of U.S. Provisional Application No. 61/333597, filed on May 11, 2010, the disclosure of which is incorporated herein by reference.

1. Field of the Invention

The invention relates generally to tracking particles and energy deposition feedback for monitoring of therapy range and dose verification in proton and other ion radiotherapy during or directly following such radiotherapy in a patient and, more particularly, to an apparatus and method for measuring prompt gamma and other beam-induced radiation during such hadron therapy treatments.

2. Related Art

Compared to conventional external radiation treatment modalities (gamma and electron beams), beams of hadronic particles such as protons or carbon ions allow a more conformal dose deposition to the tumor, with better sparing of surrounding critical structures and normal tissue. Modern delivery techniques and planning strategies, such as beam scanning and intensity modulation, may enable optimal utilization of this advantage. However, full clinical exploitation of proton-beam precision is hampered by uncertainties in the localization of the distal dose fall-off within the patient. Proton treatment-planning strategies often only utilize the lateral penumbra of the beam in the proximity of critical organs for dose conformation. Of concern are dose-calculation errors of simplified pencil-beam algorithms, and the use of empiric calibration curves between computed tomography (CT) numbers, mass (organic tissue) density and proton stopping powers, especially in the presence of tissue heterogeneities and metallic implants. Proton therapy is also sensitive to standard sources of uncertainties such as beam-delivery, patient-setup errors and organ motion. Although the use of margins in current treatment planning safety accounts for these uncertainties there is a great demand for dose monitoring and quality control in fractionated proton therapy. Two primary techniques involving measurements of secondary gamma radiation produced during and after proton beam irradiation of the organic tissues, have been proposed to date: in vivo (right after the proton therapy treatment) Positron Emission Tomography (PET), and real time (during the proton therapy treatment) measurement of secondary “prompt” gamma-ray emission arisen from inelastic proton-nucleus scattering and reaction processes that occur during proton beam delivery.

Protons deposit energy in matter through interactions with either atomic electrons or nuclei. Proton-nuclear interactions involve both elastic and inelastic processes, including nuclear capture and nuclear scattering. Nuclear capture can produce short-lived radioactive isotopes such as and ¹¹C and ¹⁵O (with half-lives of 20 min and 2 min, respectively). They are produced via nuclear interactions along the proton beam path in the irradiated tissue and by losing their kinetic energy in collisions with atoms of the surrounding matter they come to rest typically within millimeters and within a nanosecond from their point of emission. Near the stopping point an annihilation process (the positron combines with an atomic electron in the surrounding material) takes place and two gamma-ray photons, each with an energy equal of 511 keV and oppositely directed (˜180 degrees apart) are emitted simultaneously. The correlation between beam-delivered dose profiles and beam-induced β⁺-activity profiles may provide in vivo information about the effective proton paths in tissue, and can be extracted from the in-beam PET images.

Several phantom experiments and clinical trials have confirmed the feasibility of in vivo PET imaging as a technique for the verification of proton range and field lateral position, using PET imaging only systems, while dosimetry verification is still being investigated. Parodi et at., PET Imaging for Treatment Verification of Ion Therapy; Implementation and Experience at GSI Darmstadt And MGH Boston, Nucl. Instr. and Meth. in Phys. Res. A 591 282-86 (2008). Despite the promising results mainly achieved for head-and-neck tumor cases, post-radiation PET imaging has thus far suffered from several limitations including the loss/degradation of the activity signal due to physical decay and biological washout in the time elapsed between irradiation and imaging, the need of repositioning the patient at the imaging site and the internal organ motion during the prolonged PET scan. However, the recent advent of commercially available combined PET/CT scanners helped overcome the major drawbacks of post-radiation PET imaging alone, due to the availability of the additional CT information for co-registration with the planning CT.

In contrast, the proton-nucleus scattering accounts for majority of inelastic processes encountered during the irradiation of organic tissues with a proton beam. Protons collide with atomic nuclei inside the organic tissue, and scatter inelastically off nuclei, leaving these nuclei in a quantized higher-energy state, so called “excited state”. Often these excited nuclei will rapidly (within few nanoseconds) decay to a lower energy state, emitting a gamma-ray photon whose energy is equal to the difference between the two states. As these energy states are well established and mostly unique to each isotope, the energy of the emitted gamma photo becomes a unique signature of the emitting nucleus. The energy of this type of secondary produced radiation may have a broad energy range, and is known as “prompt gamma-ray emission,” or “prompt gamma.”

To date few experimental trials have been conducted to measure secondary prompt gamma radiation (or other beam-induced radiation) during proton and carbon ion beam irradiation. These measurements clearly indicated correlations between the prompt gamma distributions and the distal falloff regions. The first experimental setup designed by Min et al., used a collimated prompt gamma scanner (PGS) consisting of three layers of shielding against neutrons generated from the water phantom. The paraffin layer moderated the high-energy neutrons, while the B₄C powder captured the neutrons via B(n,γ) reaction. Min et al, Prompt Gamma Measurements for Locating the Dose Falloff Region in the Proton Therapy, Appl. Phys. Lett. 89, 183517 (2006). The lead layer surrounding the gamma detector was blocking the unwanted prompt gamma radiation. The gamma detector consisted of a CsI(T1) scintillator (SCIONIX Holland BV) attached to a photomuitiplier tube (PMT). The signal was preamplified and analyzed with a multichannel analyzer placed near the detector. These experiments were coducted using 100, 150, and 200 MeV protons incident on a water phantom. The depth versus the relative dose measured in water (using a parallel-plate ionization chamber) for these proton energies were compared with the equivalent doses measured with a prompt gamma camera. These results confirmed earlier theoretical predictions of correlation between dose distributions obtained from prompt gamma measurements and proton Bragg peak measurements, in this case with an accuracy of 1-2 mm at 100 MeV. These results revealed that prompt gamma radiation generated by the inelastic proton-nucleus interactions can be used to verify in real time the proton range in proton radiation therapy.

Another set of pioneering experiments were conducted in 73 MeV carbon ion beam by a french team, Testa et al., using the time-of-flight (TOF) technique to better discriminate the prompt gamma radiation coming directly from the carbon ion track from elastically and inelastically scattered neutrons and Compton-scattered γ-rays. Testa et al., Monitoring the Bragg Peak Location of 73 Mev/U Carbon Ions by Means of Prompt γ-Rays Measurements, Appl. Phys. Lett. 93, 093506 (2008). They combined the TOF technique with energy discrimination technique resulting in less neutron shielding and consequently minimizing the background (neutrons and scattered γ-rasin the surrounding material) contribution. The results proved that the features of the prompt gamma-ray profile (namely certain spatial information, including resolution and the detection rates) could be used for on-line (real time) monitoring of carbon ion therapy range and dose verification.

Based on the above pioneering experimental results, a research effort was initiated to design a prototype for detecting prompt gamma radiation using a scintillator and photomultipler tube type detector. Initially, trials for the development of this technology were plagued with a large background of other induced radiation that was not part of the signal of interest. In an effort to characterize this background the prompt gamma lateral profile was measured (with respect to the incident proton beam in tissue or water equivalent tissue) by using an existing matrix array of ionization chambers designed originally for direct beam profiting in conventional (x-ray) beam therapy. However, this matrix array of ionization chambers was not placed in beam as standardly employed and led to the current novel idea for indirect implementation as a new imaging technique to measure the prompt gamma, or any other beam-induced radiation (such as, for instance, positron emissions) correlated with the proton dose profile in a water equivalent material or patient. Supporting this new idea, either an array of ionization detectors such as the one described here, or a more accurate and sophisticated device based on gas-electron-multiplier (GEM) technology, can be employed.

Accordingly, there is a need to be able to measure prompt gamma and other beam-induced radiation during hadron therapy treatment to aid in the verification of dose and range in real time. In this way, a more conformal dose deposition of hadron particles during treatment of subject tissue and distribution of radiation might be more accurately delivered during the course of treatment.

### SUMMARY OF THE INVENTION

The invention satisfies the foregoing needs and avoids the drawbacks and limitations of the prior art by providing apparatus and methods for the measuring of prompt gamma and other beam-induced radiation during or directly following hadron therapy treatments. Additionally, the apparatus and methods of the invention can be incorporated into one or more systems to perform said measuring of prompt gamma and other beam-induced radiation during or directly following hadron therapy treatments. In particular, the invention provides for a GEM-based detector for prompt gamma detection.

Various aspects of the invention may include and/or may provide an apparatus or method for GEM-based detectors for prompt gamma detection by one or more of several applications, separately or in any combination with one another.

Accordingly, one aspect of the invention involves ion chamber type detectors for measuring prompt gamma radiation in proton therapy for the purpose of patient dose and range verification.

According to another aspect of the invention, a method for measuring prompt gamma radiation in proton therapy by use of ion chamber type detectors for the purpose of patient dose and range verification is provided.

Another aspect of the invention involves arrays of ion chamber type detectors for measuring prompt gamma radiation in proton therapy for the purpose of patient dose and range verification.

In another aspect of the invention, a system for measuring prompt gamma radiation in proton therapy for the purpose of patient dose and range verification is provided. The system includes at least one ion chamber type detector arranged to measure prompt gamma radiation in a patient undergoing proton therapy.

Yet another aspect of the invention involves gas-electron-multipler type detectors for measuring prompt gamma radiation in proton therapy for the purpose of patient dose and range verification.

According to another aspect of the invention, a method for measuring prompt gamma radiation in proton therapy by use of gas-electron-multiplier type detectors for the purpose of patient dose and range verification is provided.

In another aspect of the invention, a system for for measuring prompt gamma radiation in proton therapy for the purpose of patient dose and range verification is provided. The system includes at least one gas-electron-multiplier type detector arranged to measure prompt gamma radiation in a patient undergoing proton therapy.

In another aspect of the invention, ion chamber arrays and/or GEM detectors are used as real-time feedback tools for treatment replanning in proton and other radiotherapy applications.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 is a diagram of ions and electrons created during avalanches in the GEM holes traveling along lines of equipotential;

FIG. 2 is a diagram of a typical Triple GEM chamber;

FIG. 3A is diagram showing a sampling of the space points on a particle's trajectory with a TPC;

FIG. 3B is a diagram showing various projections of a muon's decay into a positron;

FIG. 4 is a diagram showing an conventional TPC utilizing end cap readout of the particle tracks;

FIG. 5 is a graph, illustratively representative of ions in the therapy beam leave the snout and deposit energy following a depth dose curve characterized by the familiar Bragg Peak which subsequently emits prompt gammas that are detected by a Triple-GEM-based detector, according to principles of the invention;

FIG. 6 depicts a representative apparatus designed in accordance with the principles of the invention;

FIG. 7A is a graph, illustratively representative of 2D prompt gamma dose depth profile measured in accordance with the principles of the invention; and

FIG. 7B is a graph, illustratively representative of 3D prompt gamma dose depth profile measured in accordance with the principles of the invention.

FIG. 8 is a graph, illustratively representative of 3D positron emitting radiation measured in accordance with the principle of the invention.

FIG. 9 is an illustration of a system configured to perform the steps of the methods disclosed herein.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

It is understood that the invention is not limited to the particular methodology, protocols, devices, apparatus, materials, applications, etc., described herein, as these may vary. It is also to be understood that the terminology used herein is used for the purpose of describing particular embodiments only, and is not intended to limit the scope of the invention. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art to which this invention belongs. Preferred methods, devices and materials are described, although any methods and materials similar or equivalent to those described herein can be used in the practice or testing of the invention.

The apparatus and methods of the invention provide for in vivo monitoring of therapy range and dose verification in proton and other ion radiotherapy such as, for example, by measuring prompt gamma and other beam-induced radiation during hadron therapy treatements. Embodiments of the invention include the apparatus, the use of such apparatus, and methods during the course of patient treatments.

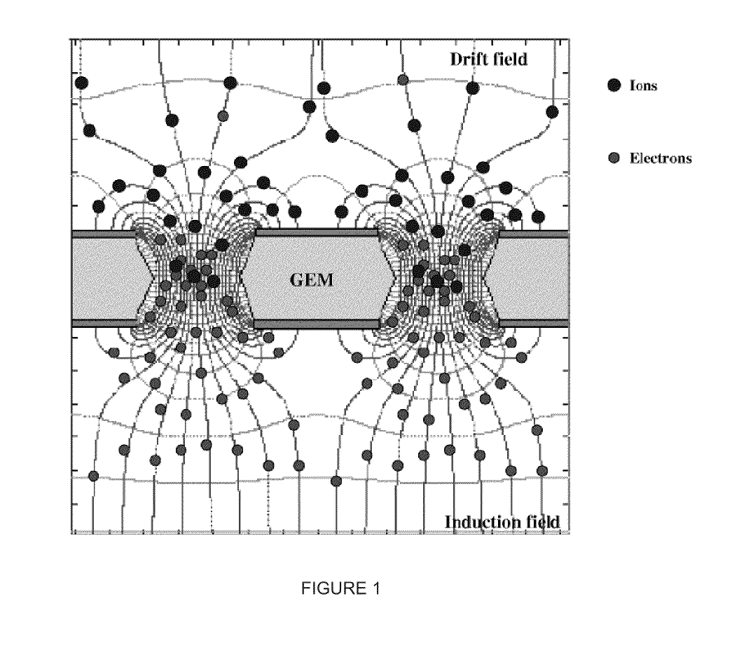

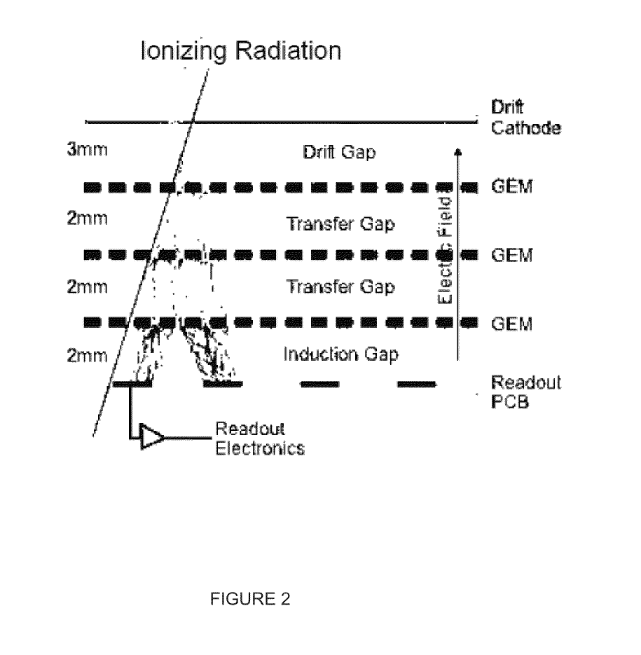

Micro-pattern gas gain elements such as MicroMegas and Gas Electron Multipliers (GEMs), as discussed in Sauli, et al., Nucl. Instr. and Meth. in Phys. Res. A 386 (1997) 531-534 were invented in the mid-1990s as an alternative to wires for the avalanche stage of time projection chambers (TPCs). By way of example, FIG. 1 is a GEM as presented by the Deutsches Elektronen-Synchrotron Group's Basic Principles of TPC and GEMs. It is made of a composite sheet of material consisting of a thin layer of insulator (typically Kapton at 50 μm thick; however, Thick GEMs insulated by G-10 are also possible, as disclosed in Chechik, et al., Nuclear Instruments and Methods in Phys. Res. A 535 (2004) 303-308) sandwiched between two thin (˜5 μm) layers of metal (typically copper) held at a potential difference of 300-500V. A mesh which consists of 50 μm diameter double-conical cross section holes and a pitch of some 100 μm is chemically etched in the foil. Other cross sections are possible (cylindrical, single-conical) but double-conical provides the best insulation between electrodes because of the longer distance that an electrical discharge would have to travel. This configuration gives rise to electric fields in each hole in upwards of 10⁵ V/cm and serves as an amplification element for the drift electrons with a gas-gain per foil on the order of 100. The separation of the multiplication and readout regions further reduces the occurrence of discharges. FIG. 2 shows a sample Triple-GEM (TGEM) as disclosed by the European Organization for Nuclear Research. As displayed in FIG. 2, in practice, a Triple-GEM (TGEM) stack with typical chamber layout and without a magnetic field present, consisting of three cascaded GEM foils, can be operated at a much lower voltage than a Single or Double-GEM for a given overall stack gain. This reduces the occurrence of discharges between the top and bottom layers of individual GEM foils.

GEMs provide several advantages when used as the drift electron amplification element in a TPC. The thin foil can easily be made into very large segmented planes or curved into cylindrical or even spherical geometries. GEMs dictate no preferred read-out shape or orientation because they have a uniform surface over which amplification can occur. Shower electrons can be collected on electrodes in a grid pattern or in a multi-angled strip pattern to reduce the number of channels necessary. Furthermore, positive ion backdrift, which can be 20-30% in a typical Multi-Wire Proportional Counter, is a few percent or less in a GEM-based detector and causes negligible field distortion. Sauli, et al., IEEE Transactions on Nuclear Science, vol. 50 (2003), p. 803. The thin GEM foil mesh provides minimal energy loss for scattered particles. GEMs possess several other advantageous and desirable qualities when paired with modern fast electronics; high rate capability (hundreds of MHz/cm²) has been observed when used with fast drift gases; good time resolution (4 ns) can be achieved with the proper choice of drift gas; spatial resolution on the order of tens of microns is possible, depending on the readout geometry; and GEMs have been in operation in harsh radiation environments for quite some time with good aging resistance. Bachmann, et al., Nucl. Instr. and Meth. in Phys. Res. A 461 (2001) 42-46; Murtas, et al., Nucl. Instr. and Meth. in Phys. Res. A 617 (2010) 237-241. GEMs are extremely versatile and have been shown in the relatively short time since their invention to have applications in, not only nuclear and particle physics but also in plasma diagnostics, gas photomultiplication, digital radiography, and diagnostic imaging.

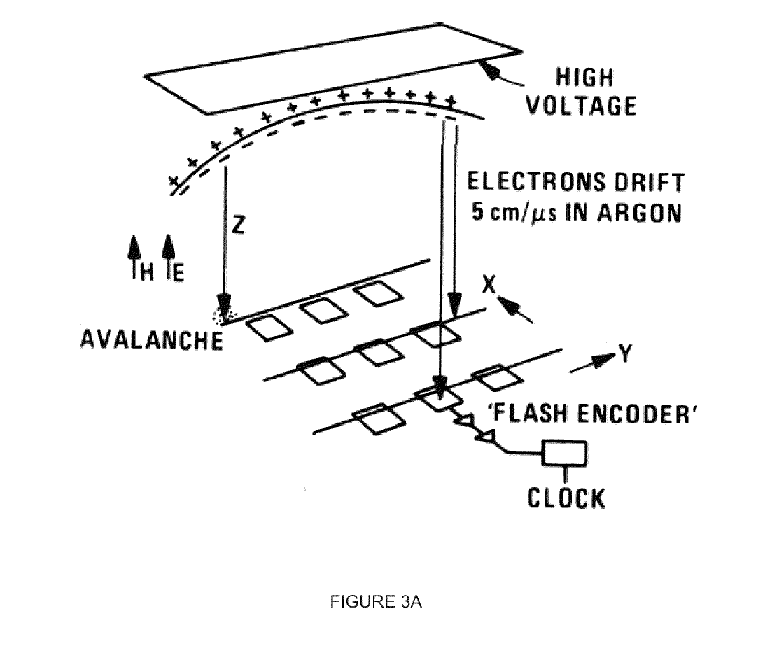

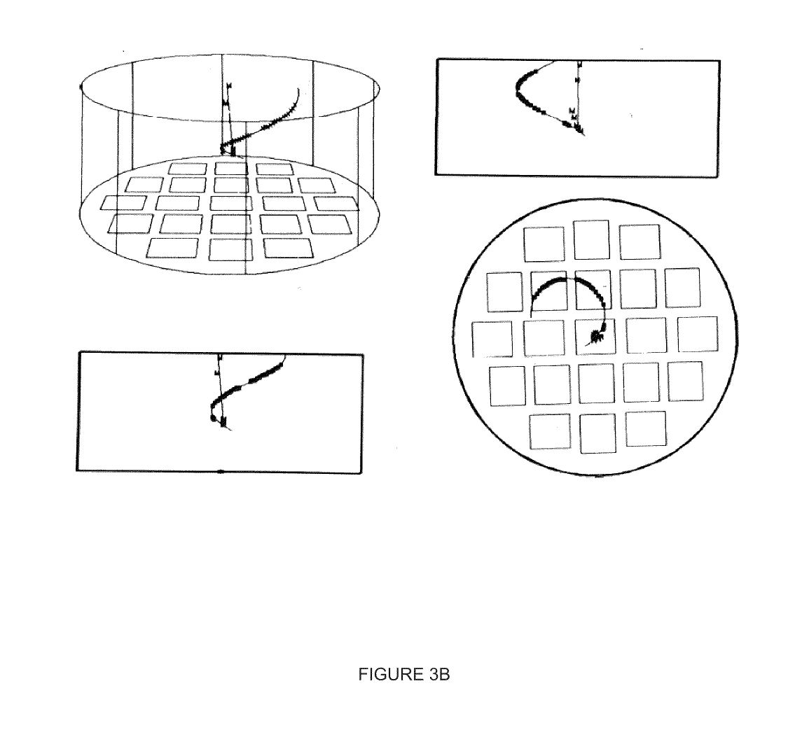

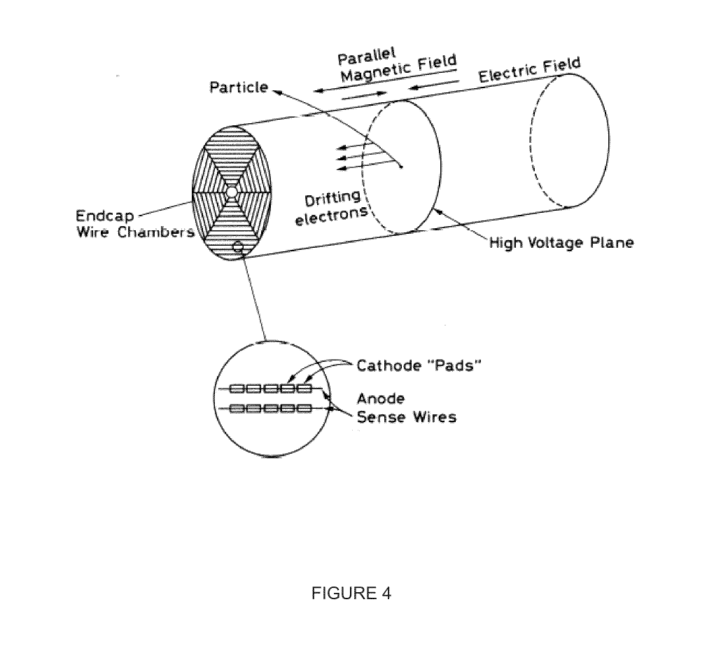

As discussed in Nygren, Berkeley 1974 Proceedings, Pep Summer Study, PEP-0144 (1976), time projection chambers are routinely used in collider experiments to measure 3D particle tracks in high-rate environments. A TPC, like a bubble chamber, can simultaneously make measurements of the track and specific energy loss, dE/dx, of many particles and has therefore been referred to as an electronic bubble chamber due to its fast, all digital readout, As ionizing radiation enters a volume of gas held in an electric field, the electrons liberated in the ionization process travel away from the cathode along the electric field lines towards the anode structures. Using the information given by the signal time and the spatial position of the readout element, the initial point of ionization can be reconstructed. FIGS. 3A and 3B illustrate a TPC in operation, as disclosed in Leo, Techniques for Nuclear and Particle Physics Experiments, (Springer Verlag, New York, 1994). As displayed in FIGS. 3A and 3B, TPCs measure the path of the track at many points, which leads to excellent position and momentum resolution. FIG. 3A depicts a sampling of the space points on a particle's trajectory with a TPC. FIG. 3B depicts various views of a muon's decay into a positron. The signal is registered on readout pads represented by boxes on the bottom of the cylindrical volume. The muon is marked by an M. Furthermore the timing resolution enables precise measurement of the energy deposited in each volume element (voxel) so that particle identification can be achieved. Conventional cylindrical TPCs are constructed so that the electric field, the magnetic field (if required for improved charged particle identification from curvature), and the central axis are parallel. For instance, FIG. 4 depicts a conventional TPC utilizing end cap readout of the particle tracks as presented by Leo, Techniques for Nuclear and Particle Physics Experiments, (Springer Verlag, New York, 1994). This TPC uses Anode sense wires for the charge amplification. The magnetic and electric fields in this configuration are parallel. This simple configuration causes ionization electrons to travel in straight lines at a constant speed. The cathode lies at one end of the cylinder in a plane perpendicular to the central axis with amplification and readout occurring on the opposite end. Other configurations include radial drift TPCs with readout elements located on the curved surface of an outer cylindrical or spherical shell.

In addition to a GEM-based TPC, two-dimensional detector implementation based on GEM technology with only energy and lateral position reconstruction can be realized by building a chamber with a very small drift gap. Such a detector relies on only integrated charge deposit and location to reconstruct the cross sectional dose. Another option involves reflecting and collecting the scintillation light emitted from the GEM holes with a mirror focused on a low-noise CCD camera. The aforementioned methods (the electronic and optical modes, respectively) have been used by several groups for 2D-dosimetry, imaging, and depth dose profiling in conjunction with a water bellows placed in front of the detector to scan the Bragg Peak. Fetal, et al., Nucl. Instr. and Meth. Phys. Res. A 513 (2003) 42-46; Fraga, et al., Nucl. Instr. and Meth. in Phys. Res. A 513 (2003) 379-387.

GEMs can serve as a natural replacement for the dynode amplification stages of a conventional PMT. The gas PMT is filled with a typical noble drift gas mixture and optionally sealed, depending on the detector size. A stand-alone photocathode can be used for the conversion of photons into drift electrons with subsequent collection on a standard GEM foil or the surface of the GEM itself can be coated with the photocathode material. Avalanche electrons are collected on a single anode or focused onto the bottom of the last GEM foil, depending on the polarity of the induction electric field. Multiple anode readout pads can provide the gas PMT with position sensitive features.

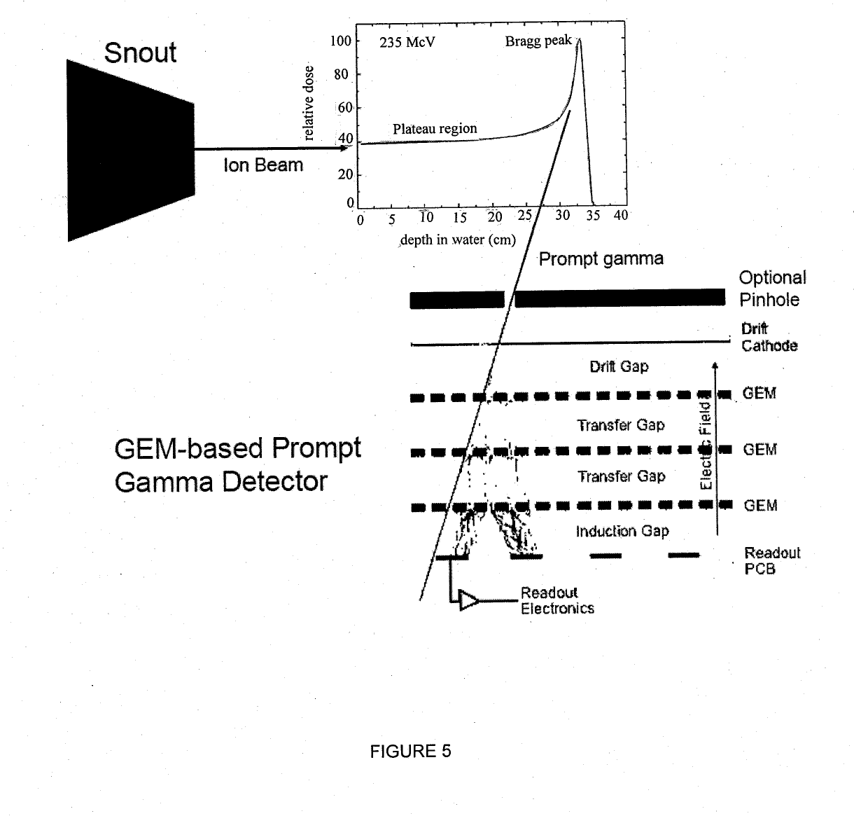

GEMs in particular provide an elegant application to the problem of prompt gamma reconstruction in a number of ways. The increased width of the drift region in a TPC configuration would provide timing information to the gamma-induced signals. In this way each photon (and other secondary particles) produced along the incident proton's path could be tracked in three dimensions. Furthermore, the proton beam pulse timing could be used as a trigger and combined with the GEM chamber's signal information to precisely isolate the origin of the tracked particle within the body. An optimization of gas mixture, signal pad size, geometry and timing could result in an extremely accurate real-time picture of the path of the proton beam in the patient. FIG. 5 depicts ions in the therapy beam leaving the snout and depositing energy following a depth dose curve characterized by the familiar Bragg Peak as can be found in the International Atomic Energy Agency's Technical Report Series #398. FIG. 5 also depicts the GEM based prompt gamma detector with a pinhole in place to aid in the selection of signals which appear to originate from the beam line. The pinhole option would only be introduced if necessary to improve beam imaging and reconstruction. Those photons which leave only a single cluster of ionization along their path could be combined with the pinhole to project back and find their intersection with the plane lying longitudinal to the beam direction and lateral to the central axis of the detector. Background events caused by the shower of photons produced by neutrons in the High-Z material of the pinhole plane can be rejected according to their apparent production position on the beam line plane.

We note that, while certain aspects of the GEM technology may be one solution for tracking particles and energy deposition feedback, an ionization detector array capable of 2D imaging will provide both range and dose verification in proton radiotherapy. Several tests of the latter were conducted and confirmed the possibility of detecting and mapping the prompt gamma radiation profile by using a commercially available matrix array of vented parallel plate ionization chambers. These tests confirmed the correlation of proton depth dose profile with the prompt gamma dose profile. We note that this device was not initially made for this application, and that we consider the use of it for this purpose completely novel. The proof-of-principle employed here supports future improvements leading to a dedicated device with, for instance, improved spatial resolution and absolute dosimetry capability. As a quality assurance tool in proton radiotherapy, this device could provide real-time feedback for range and dose during patient treatments—features highly desirable and unavailable at the current time. Given these capabilities, this device could facilitate real time treatment planning adjustments.

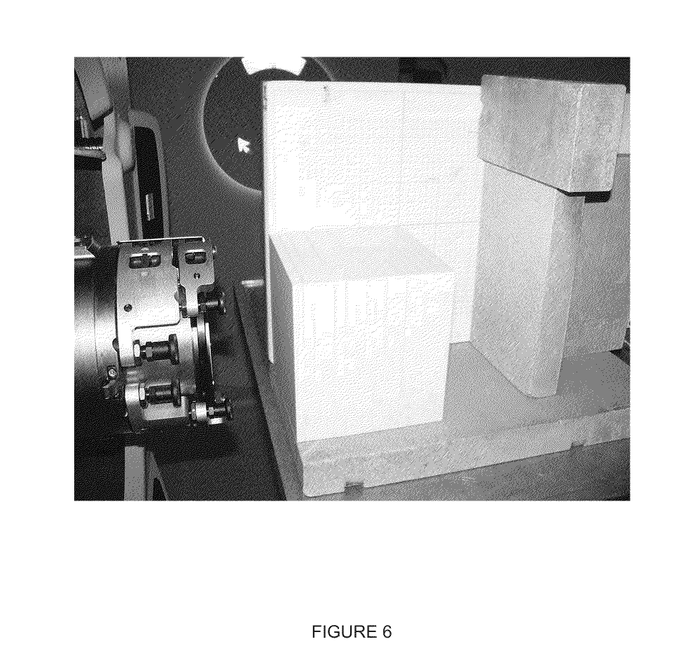

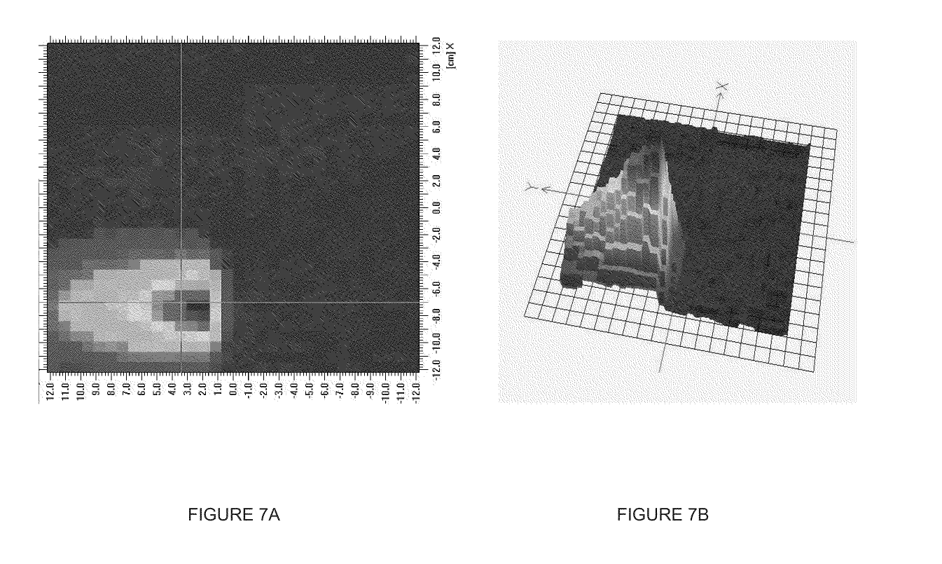

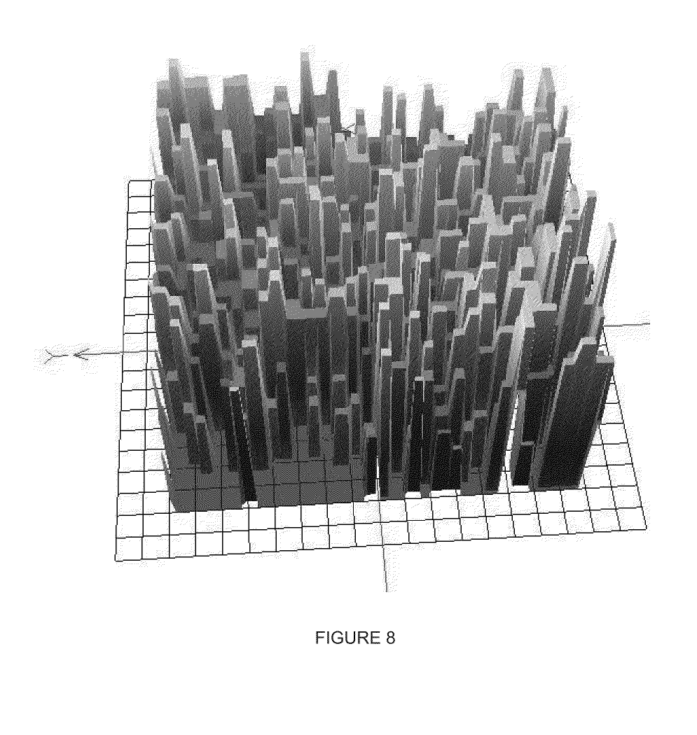

One embodiment of the present invention is shown in the FIG. 6, while the results are shown in the FIGS. 7A, 7B and 8. In this case 12 g/cm² range and a 4 cm modulated proton beam is delivered onto a 16 cm thick water equivalent polymethyl methacrylate (PMMA)) block. The matrix array of pixel ionization chambers was situated laterally abutting the PMMA block (as shown in the FIG. 6) and its electronics were shielded with a boron enriched poliethylene (tor thermal neutron shielding). A matrix array of parallel plate ionization chambers is used for measuring the secondary produced prompt gamma radiation. These measurements may be presented as 2D prompt gamma dose depth profile measured with an ionization chamber array correlated with a proton dose coming from the left irradiates a set of 16 PMMA blocks of 1 cm each, as presented in FIG. 7A. These measurements may also be presented as a 3D prompt gamma dose depth profile generated using OmniPro-IMRT software, which basically depicts the equivalent dose collected by each parallel plate ionization chamber, as presented in FIG. 7B. FIG. 8 is a graph that represents a 3D positron emitting radiation, detected immediately after the irradiation of the water equivalent PMMA block with a modulated proton beam having 12 g/cm² range and a 10 g/cm² spread out Bragg peak width. The information acquired by the detector array shows that this type of device can be used to measure annihilation radiation.

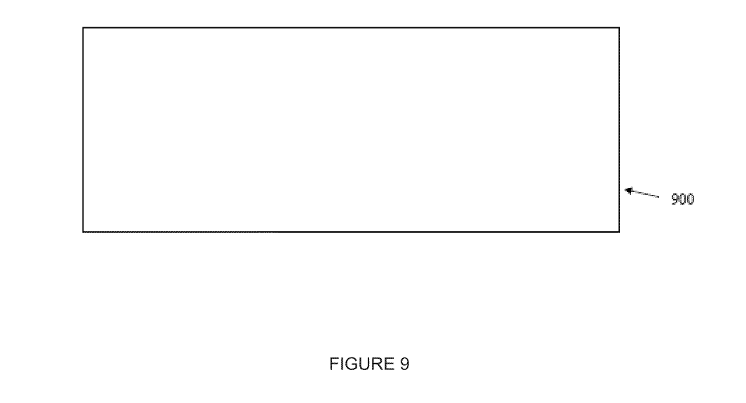

FIG. 9 is an illustration of a system configured to perform the steps of the methods disclosed herein. The system 900 provides for, through execution of said methods, measurement of radiation during or directly following hadron therapy treatment in a patient for dose and range verification purposes. The system may comprise multiple components.

Various modifications and variations of the described methods and systems of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed:

1. An apparatus for measuring beam-induced radiation in a target site of a patient undergoing radiation therapy during or directly following administration of hadronic particles in said patient, comprising at least one ion chamber type detector for obtaining a measurement of said beam-induced radiation.

2. The apparatus of claim 1, wherein said radiation therapy is proton therapy.

3. The apparatus of claim 1, wherein said radiation therapy is Carbon or other heavy ion therapy.

4. The apparatus of claim 1, wherein said beam-induced radiation is prompt gamma.

5. The apparatus of claim 1, wherein said beam-induced radiation are photons from positron annhilation.

6. An apparatus for measuring beam-induced radiation in a target site of a patient undergoing radiation therapy during or directly following administration of hadronic particles in said patient, comprising at least one gas-electron-multipler-type detector for obtaining a measurement of said beam-induced radiation.

7. The apparatus of claim 6, wherein said radiation therapy is proton therapy.

8. The apparatus of claim 6, wherein said radiation therapy is Carbon or other heavy ion therapy.

9. The apparatus of claim 6, wherein said beam-induced radiation is prompt gamma.

10. The apparatus of claim 6, wherein said beam-induced radiation are photons from positron annhilation.

11. The apparatus of claim 6, wherein said at least one gas-electron-multiplier-type detector obtains a measurement of spatial information.

12. The apparatus of claim 6, wherein said at least one gas-electron-multiplier-type detector obtains a measurement of spatial information and particle track reconstruction.

13. The apparatus of claim 6, wherein said at least one gas-electron-multiplier-type detector obtains a measurement of energy information.

14. The apparatus of claim 7, wherein said at least one gas-electron-multiplier-type detector obtains a measurement of spatial information.

15. The apparatus of claim 7, wherein said at least one gas-electron-multiplier-type detector obtains a measurement of spatial information and particle track reconstruction.

16. The apparatus of claim 7, wherein said at least one gas-electron-multiplier-type detector obtains a measurement of energy information.

17. The apparatus of claim 9, wherein said at least one gas-electron-multiplier-type detector obtains a measurement of spatial information.

18. The apparatus of claim 9, wherein said at least one gas-electron-multiplier-type detector obtains a measurement of spatial information and particle track reconstruction.

19. The apparatus of claim 9, wherein said at least one gas-electron-multiplier-type detector obtains a measurement of energy information.

20. A method for measuring beam-induced radiation in a target site of a patient undergoing radiation therapy during or directly following administration of hadronic particles in said patient, said method comprising:
obtaining a measurement of said beam-induced radiation from a least one ion chamber type detector; and
calculating at least one of the dose and the range of said hadronic particles within the target site of said patient based upon said measurement.

21. The method of claim 20, wherein said radiation therapy is proton therapy.

22. The method of claim 20, wherein said radiation therapy is Carbon or other heavy ion therapy.

23. The method of claim 20, wherein said beam-induced radiation is prompt gamma.

24. The method of claim 20, further comprising the step of replanning or modifying said radiation therapy based upon said measurement.

25. A system configured to perform the steps according to method claim 20.

26. A method for measuring beam-induced radiation in a target site of a patient undergoing radiation therapy during or directly following administration of hadronic particles in said patient, said method comprising:
obtaining a measurement of said beam-induced radiation from at least one gas-electron-multiplier-type detector; and
calculating at least one of the dose and the range of said hadronic particles within the target site of said patient based upon said measurement.

27. The method of claim 26, wherein said radiation therapy is proton therapy.

28. The method of claim 26, wherein said beam-induced radiation is prompt gamma.

29. The method of claim 26, wherein said beam-induced radiation are photons from positron annhilation.

30. The method of claim 26, further comprising the step of replanning or modifying said radiation therapy in real time based upon said measurement.

31. The method of claim 26, wherein said at least one gas-electron-multiplier-type detector obtains a measurement of spatial information.

32. The method of claim 26, wherein said at least one gas-electron-multiplier-type detector obtains a measurement of spatial information and particle track reconstruction.

33. The method of claim 26, wherein said at least one gas-electron-multiplier-type detector obtains a measurement of energy information.

34. A system configured to perform the steps according to method claim 26.

35. The method of claim 27, wherein said at least one gas-electron-multiplier-type detector obtains a measurement of spatial information.

36. The method of claim 27, wherein said at least one gas-electron-muitiplier-type detector obtains a measurement of spatial information and particle track reconstruction.

37. The method of claim 27, wherein said at least one gas-electron-multiplier-type detector obtains a measurement of energy information.

38. The method of claim 28, wherein said at least one gas-electron-multiplier-type detector obtains a measurement of spatial information.

39. The method of claim 28, wherein said at least one gas-electron-multiplier-type detector obtains a measurement of spatial information and particle track reconstruction.

40. The method of claim 28, wherein said at least one gas-electron-multiplier-type detector obtains a measurement of energy information.
